(19) United States
(12) Patent Application Publication
(10) Pub. No.: US 2004/0122774 A1
(43) Pub. Date: Jun. 24, 2004

(54) Method and system for executing applications on a mobile device

(76) Inventors: Martin Studd, Middletown, NJ (US); Martin Watson, Minneapolis, MN (US); Chris Alme, St. Paul, MN (US)

Correspondence Address: Schwegman, Lundberg,, Woessner & Kluth, P.A., P.O. Box 2938, Minneapolis, MN, 55402, US

(21) Appl. No.: 10/631,612

(22) Filed: Jul. 31, 2003

Related U.S. Application Data
(60) Provisional application No. 60/430,482, filed on Dec. 3, 2002.
(60) Provisional application No. 60/400,571, filed on Aug. 2, 2002.

(51) Int. Cl. G06F 17/60; H04L 9/32

(52) U.S. Cl. 705/65; 713/202; 705/1

(57) ABSTRACT

A method and apparatus for integrating and instantiating custom applications in a multi-application smart card system are described. In one embodiment, the method includes receiving an indication that a mobile device is present, where the mobile device includes a first set of one or more mobile device applications, and where each mobile device application is associated with one or more of a second set of framework applications. The method also includes selecting a mobile device application from the first set. The method also includes selecting a framework application from the second set, wherein the mobile device application is associated with the framework application. The method further includes activating the framework application, wherein activating includes successfully authenticating device; and after activating the framework application, receiving transaction data from the mobile device application.

### CROSS REFERENCE TO RELATED APPLICATIONS

This applications claims priority to U.S. Provisional Patent application No. 60/430,482, filed on Aug. 2, 2002, which is hereby incorporated by reference. This application also claims priority to U.S. Provisional Patent application No. 60/400,571, filed Dec. 3, 2002, which is hereby incorporated by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of smart cards and more specifically to multi-application smart cards.

### BACKGROUND

Typically, business transactions involve several parties. In certain business transactions, the parties include service providers, affiliated parties, and sponsors. The service providers directly provide services to the affiliated parties, while the sponsors indirectly provide services to the affiliated parties. In such business transactions, service providers often need information from several different sponsors in order to service their affiliated parties. For example, in medical services transactions, physicians (e.g., service providers) typically need information about patients (e.g., affiliated parties) from health insurance companies (e.g., sponsors) associated with the affiliated parties. In health services transactions, information exchange is needed because physicians typically need patients' personal and health insurance information to determine what health services the patients' health insurance companies will pay for. In some cases, physicians interact with multiple sponsors because patients belong to multiple health plans. In addition to medical transactions, other transactions such as airline transactions, pharmacy transactions, and auto insurance transactions, require similar information exchange between service providers, affiliated parties, and sponsors.

Several solutions have been offered to facilitate information exchange between parties to a transaction. In order to provide differentiable service, each sponsor will typically insist that service providers use their unique functionality and information, rather than using an aggregator to present a common interface representing all sponsors. Sponsors will also typically require that they control this unique functionality and that it be securely held and only be made available for interactions related to their affiliated parties. In order to support this, several Internet-based applications have been designed to exchange information between service providers, affiliated parties, and sponsors. However, the disadvantage with this is that many of the prior art Internet-based solutions require service providers to navigate to various different Sponsor websites to retrieve desired information. Yet another disadvantage is that many prior art Internet browser-based applications require service providers to manually enter relatively long strings of affiliated party information (e.g., a patient's name, address, etc.) before accessing desired affiliated party and sponsor information.

### SUMMARY

A method and apparatus for integrating and instantiating custom applications in a multi-application smart card system are described. In one embodiment, the method includes receiving an indication that a mobile device is present, where the mobile device includes a first set of one or more mobile device applications, and where each mobile device application is associated with one or more of a second set of framework applications. The method also includes selecting a mobile device application from the first set. The method also includes selecting a framework application from the second set, wherein the mobile device application is associated with the framework application. The method further includes activating the framework application, wherein activating includes successfully authenticating the mobile device; and after activating the framework application, receiving transaction data from the mobile device application.

### BRIEF DESCRIPTION OF THE FIGURES

The present invention is illustrated by way of example and not limitation in the Figures of the accompanying drawings, in which like references indicate similar elements and in which:

FIG. 1 illustrates an exemplary computer system used in conjunction with certain embodiments of the invention;

FIG. 2 is a block diagram illustrating an exemplary computer network, used in conjunction with certain embodiments of the invention;

FIG. 3 is a block diagram illustrating an architecture for transmitting data between framework applications and mobile device applications, according to exemplary embodiments of the invention;

FIG. 4 is a block diagram illustrating an alternative architecture for transmitting data between framework applications and mobile device applications, according to exemplary embodiments of the invention;

FIG. 5 is a block diagram illustrating an architecture for the smart card shown in FIG. 4, according to embodiments of the invention;

FIG. 6 is a flow diagram illustrating operations for exchanging data with a mobile device, according to exemplary embodiments of the invention;

FIG. 7 is a continuation of the flow diagram of FIG. 6, illustrating additional operations for exchanging data with a mobile device, according to exemplary embodiments of the invention;

FIG. 8 is a flow diagram illustrating operations for exchanging data with an application framework, according to embodiments of the invention;

FIG. 9 is a flow diagram illustrating operations for authenticating a mobile device using an authentication device, according to exemplar embodiments of the invention;

FIG. 10 is a flow diagram illustrating operations performed by an authentication device for authenticating a mobile device, according to embodiments of the invention;

FIG. 11 is a flow diagram illustrating operations for receiving framework and mobile device applications in a server and, according to embodiments of the invention;

FIG. 12 is a flow diagram illustrating operations for transmitting modified/new framework applications from a server to a computing device;

FIG. 13 is a flow diagram illustrating operations for receiving a framework application from a server, according to embodiments of the invention;

FIG. 14 is a flow diagram illustrating operations for installing a modified/new mobile device application from a server to a mobile device, according to embodiments of the invention; and

FIG. 15 is a flow diagram illustrating operations for receiving a modified/new mobile device application in a mobile device, according to embodiments of the invention.

FIG. 16 is a flow diagram illustrating actions performed by an affiliated party in the course of a medical services transaction, according to embodiments of the invention.

FIG. 17 is a flow diagram illustrating actions performed by a health provider in the course of a medical services transaction, according to embodiments of the invention.

### DESCRIPTION OF THE EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams.

This description of the embodiments is divided into three sections. In the first section, an exemplary hardware and operating environment is described. In the second section, a system level overview is presented. In the third section, an exemplary implementation is described.

### Hardware and Operating Environment

This section provides an overview of the exemplary hardware and the operating environment in which embodiments of the invention can be practiced.

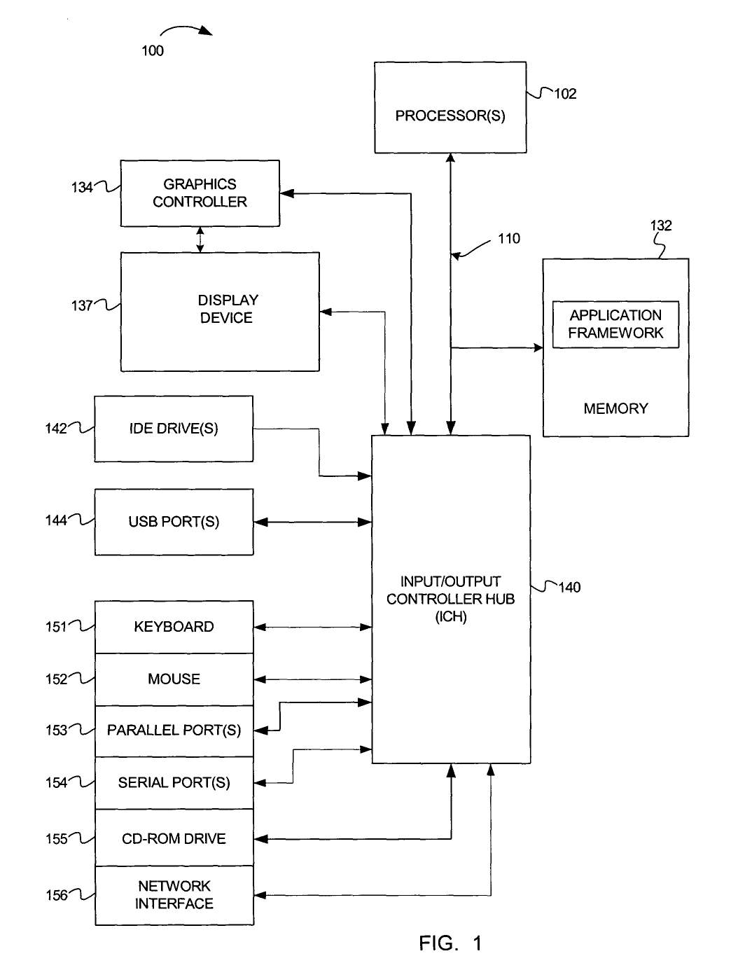

FIG. 1 illustrates an exemplary computer system used in conjunction with certain embodiments of the invention. As illustrated in FIG. 1, computer system 100 comprises a processor(s) 102. Computer system 100 also includes a memory 132, processor bus 110, and input/output controller hub (ICH) 140. The processor(s) 102 and ICH 140 are coupled to the processor bus 110. The processor(s) 102 may comprise any suitable processor architecture. The computer system 100 may comprise one, two, three, or more processors, any of which may execute a set of instructions in accordance with embodiments of the present invention.

The memory 132, which stores data and/or instructions, may comprise any suitable memory, such as a dynamic random access memory (DRAM), for example. In one embodiment, the memory 132 includes an application framework for exchanging data with mobile devices, as described in greater detail below. The computer system 100 also includes IDE drive(s) 142 and/or other suitable storage devices. A graphics controller 134 controls the display of information on a display device 137, according to embodiments of the invention.

The input/output controller hub (ICH) 140 provides an interface to I/O devices or peripheral components for the computer system 100. The ICH 140 may comprise any suitable interface controller to provide for any suitable communication link to the processor(s) 102 and/or to any suitable device or component in communication with the ICH 140. For one embodiment of the invention, the ICH 140 provides suitable arbitration and buffering for each interface.

For one embodiment of the invention, the ICH 140 provides an interface to one or more suitable integrated drive electronics (IDE) drives 142, such as a hard disk drive (HDD) or compact disc read only memory (CD ROM) drive, or to suitable universal serial bus (USB) devices through one or more USB ports 144. For one embodiment, the ICH 140 also provides an interface to a keyboard 151, a mouse 152, a CD-ROM drive 155, one or more suitable devices through one or more parallel ports 153 (e.g., a printer), and one or more suitable devices through one or more serial ports 154. For one embodiment of the invention, the ICH 140 also provides a network interface 156 though which the computer system 100 can communicate with other computers and/or devices. In one embodiment, the computer system 100 includes a machine-readable medium that stores a set of instructions (e.g., software) embodying any one, or all, of the methodologies described herein. Furthermore, software can reside, completely or at least partially, within memory 132 and/or within the processor(s) 102. According to embodiments of the invention, the computer system can be a personal digital assistant (PDA), tablet PC, notebook computer, cellular telephone, or other similar computer system.

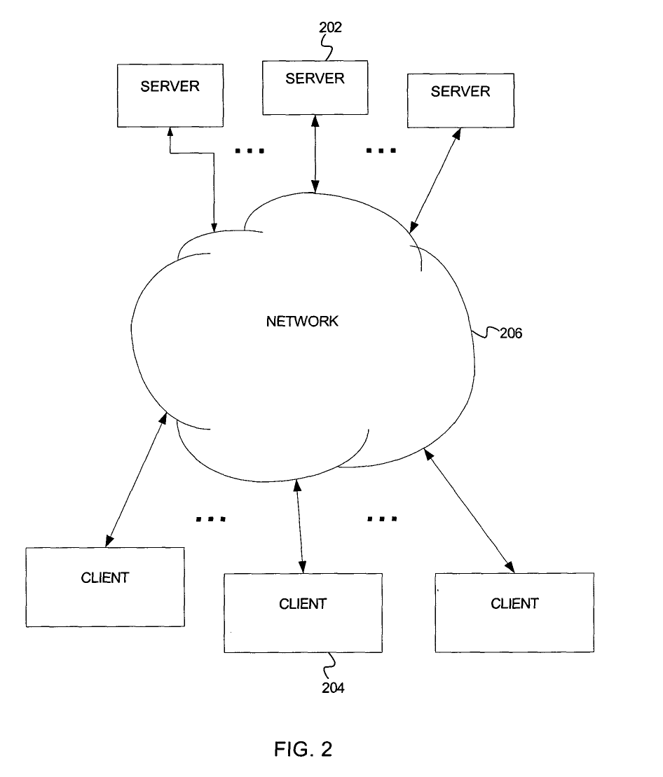

FIG. 2 is a block diagram illustrating an exemplary computer network, used in conjunction with certain embodiments of the invention. In FIG. 2, a number of servers 202 are coupled to a network 206. According to embodiment, the network 206 can be any suitable network. For example, network 206 may be a private wide area network or a global network such as the Internet and/or the World Wide Web. Moreover, the network 206 can be any suitable standardized network, such as Ethernet. The network 206 is coupled to a number of clients 204. The clients 204 and servers 202 can communicate over telephone lines, ISDN lines, fiber-optic lines, wireless network links and/or other suitable communication channels using any suitable protocol suite, such as TCP/IP.

The servers 202 and clients 204 can be computer systems similar to the one described in FIG. 1. Alternatively, the clients and servers can be other network devices such as cellular telephones, wireless personal digital assistants, tablet PCs, etc.

### System Level Overview

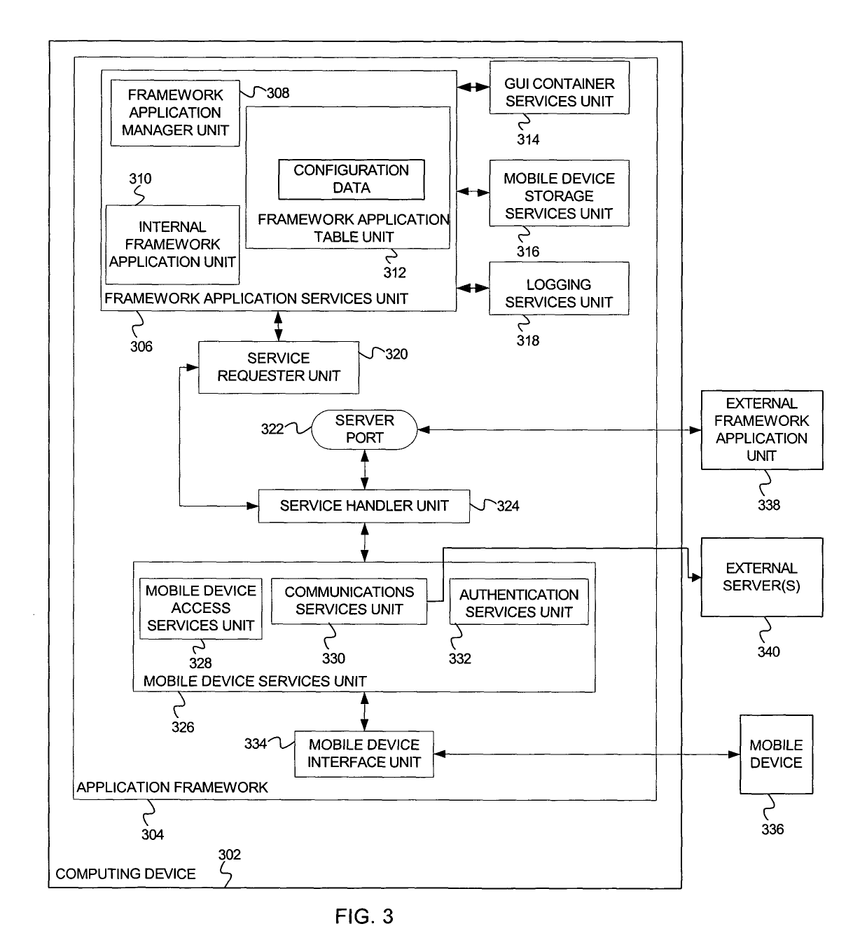

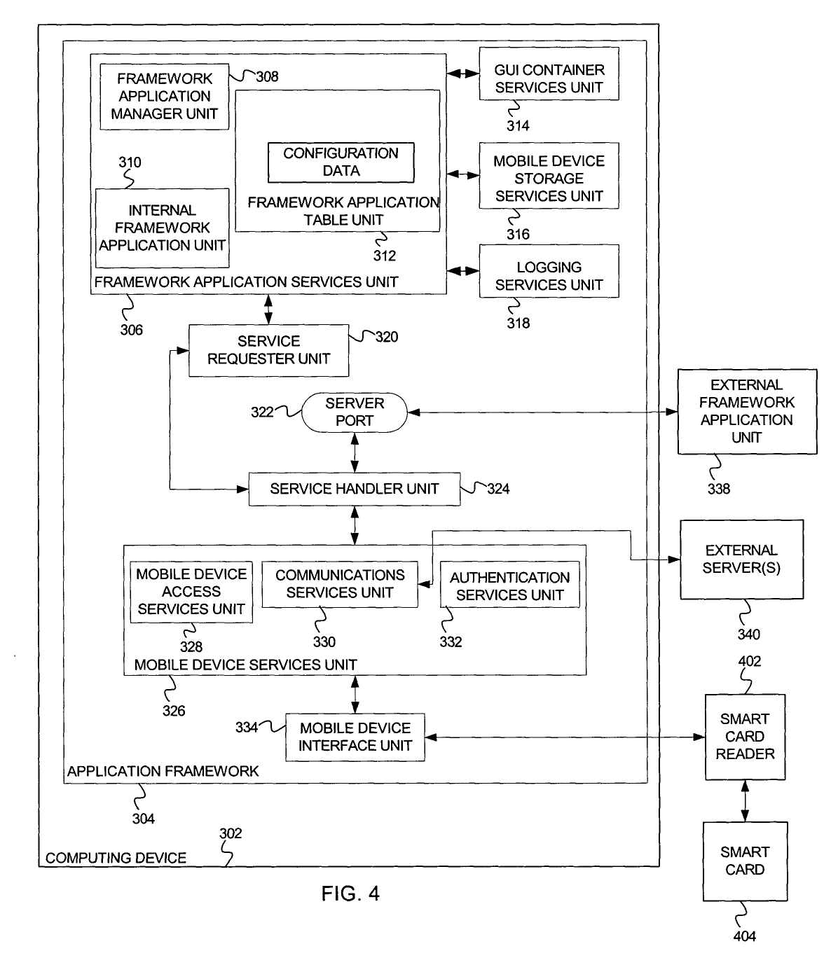

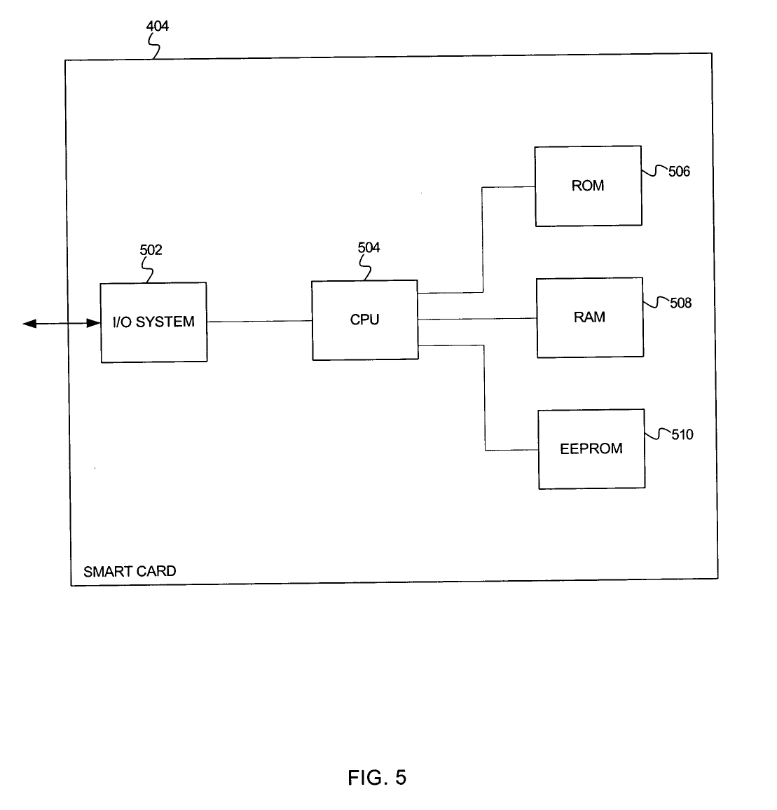

This section provides a system level overview of exemplary embodiments of the invention. While FIGS. 1-2 describe a computer system and network used in conjunction with certain embodiments of the invention, FIGS. 3-4 describe an application framework for transmitting data between mobile device applications and applications running in conjunction with the application framework. FIG. 5 describes an exemplary mobile device, which is used with the application framework described in FIGS. 3-4.

FIG. 3 is a block diagram illustrating an architecture for transmitting data between framework applications and mobile device applications, according to exemplary embodiments of the invention. As shown in FIG. 3, a computing device 302 includes an application framework 304. In one embodiment, the computing device 302 is similar to the computer system described in FIG. 1. In an alternative embodiment, the computing device 302 is a notebook computer, PDA, tablet PC, cellular telephone, or other suitable computing device.

As shown in FIG. 3, the application framework 304 includes a GUI container services unit 314, which is connected to a framework application services unit 306. A mobile device storage services unit 316 and a logging services unit 318 are also both connected to the framework applications services unit 306. In one embodiment, the mobile device storage services unit 316 enables internal framework applications to utilize storage available on a mobile device. In one embodiment, the logging services unit 318 enables internal framework applications to log (i.e., record) internal framework application events. In one embodiment, the GUI container services unit 314 formats application framework applications' graphical user interfaces.

As shown in FIG. 3, the framework application services unit 306 includes a framework application manager unit 308, internal framework application unit 310, and a framework application table unit 312. In one embodiment, the internal framework application unit 310 stores a set of one or more internal framework applications. In one embodiment, the internal framework applications are Java applications. In one embodiment, the framework application table unit 312 includes configuration data used for configuring the internal framework applications when they are activated, as described in more detail below. In one embodiment, the framework application manager unit 308 initiates and terminates internal and external framework applications in response to mobile devices, as described in greater detail below.

In FIG. 3, the framework application services unit 306 is connected to a service requester unit 320. In one embodiment, the service requester unit 320 receives requests for services (e.g., authentication services, data access services, etc.) that facilitate communications with mobile devices. In one embodiment, the service requester unit 320 provides a level of abstraction to the framework application services unit 306. For example, the framework application services unit 306 can obtain various mobile device services by sending a request in a predetermined format to the service requester unit 320, without knowledge of the application framework mechanisms that will provide the requested services. The service requester 320 is connected to a service handler unit 324. The service handler unit 324 is connected to a server port 322, which communicates with an external framework application unit 338. In one embodiment, the service handler unit 324 also provides a level of abstraction to the external framework application unit 338 and the service requester unit 320, as it receives service requests and forwards them to a service provider. In one embodiment, the external framework application unit 338 is connected to the server port 322 over a network connection. In one embodiment, the network connection is wireless, while alternative embodiments call for wired connections.

As shown in FIG. 3, the service handler unit 324 is also connected to a mobile device services unit 326, which is connected to a mobile device interface unit 334. The mobile device services unit 326 includes a mobile device access services unit 328, a communication services unit 330, and an authentication services unit 332. In one embodiment, the mobile device access services unit 328 services requests for data stored on a mobile device. In one embodiment, the communication services unit 330 transmits messages between application framework units (e.g., the framework application services unit 306) and external servers 340 available via a network. In one embodiment, the authentication services unit 332 services requests to authenticate a mobile device. In one embodiment, the mobile device interface 334 is connected to an external authentication device (not shown). In servicing authentication requests, the authentication services unit 332 can exchange data with the external authentication device (not shown). According to embodiments of the invention, the external authentication device can be a keypad, retinal scanner, fingerprint scanner, speech analyzer, or other suitable device. Alternatively the authentication device can be an internal device or a software application or other mechanism for performing the requested authentication functions.

In FIG. 3, the mobile device interface unit 334 is connected to a mobile device 336, via a mobile device reader unit (not shown). In one embodiment, the mobile device 336 is a smart card as described in greater detail below, with reference to FIG. 5. According to embodiments of the invention, the mobile device can be a cellular telephone, PDA, tablet PC, token device, or other suitable device. According to alternative embodiments, the mobile device is a contact or contact-less device. In one embodiment, the mobile device 336 has a contact-less connection to the mobile device reader unit (not shown). In one embodiment, the mobile device 336 includes a set of one or more mobile device applications, where each mobile device application includes transaction data. In one embodiment, the mobile device applications are purely components of data. In one embodiment, the transaction data includes information about an affiliated party, sponsor, and/or service provider, who may be involved in a business transaction. For example, in a medical services transaction, the transaction data includes a patient's personal information (e.g., name, address, etc.), health insurance information (e.g., the patient's health insurance policy number, copayment information, etc.), healthcare or other financial account information, and/or a physician's information (e.g., billing rates etc.). In one embodiment, the computing device, including the application framework 304, is located at a service provider location (e.g., a physician's office).

According to embodiments of the invention, the units (e.g., framework application services unit 306, service requestor unit 320, etc.) shown in FIG. 3 can be various processors, application specific integrated circuits (ASICs), memories, and/or machine-readable media for performing operations according to embodiments of the invention. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other form of propagated signals (e.g., carrier waves, infrared signals, digital signals, etc.), etc.

In one embodiment, the units of the application framework 304 are machine-readable media executing on a processor to carryout the operations described herein. However, in alternative embodiments, the units of the application framework are other types of logic (e.g., digital logic) for executing the operations described herein. The operations of these units will be described in further detail below.

FIG. 4 is a block diagram illustrating an architecture for transmitting data between framework applications and smart card applications, according to exemplary embodiments of the invention. The architecture shown in FIG. 4 is similar to the architecture of FIG. 3. FIG. 4 differs from FIG. 3 in that the mobile device interface unit 334 of FIG. 4 is connected to a smart card reader 402 (the mobile device reader unit (not shown in FIG. 3). The smart card reader 402 is connected to a smart card 404 (the mobile device 336).

FIG. 5 is a block diagram illustrating an architecture for the smart card shown in FIG. 4, according to embodiments of the invention. In FIG. 5, the smart card 404 includes an 10 system 502, which is connected to a CPU (central processing unit) 504. In one embodiment, the I/O system 502 transmits and receives application protocol data units (APDUs) to and from the CPU 504.

As shown in FIG. 5, the CPU 504 is connected to a ROM (read-only memory) 506, RAM 508 (random access memory), and EEPROM (erasable programmable read-only memory) 510. In one embodiment, the ROM 506 stores an operating system, while the RAM 508 provides temporary storage for the smart card 404. In one embodiment, the EEPROM 510 stores a set of one or more smart card applications (i.e., software), which are executed on the CPU 504. In one embodiment, the smart card applications are Java Card applets. In alternative embodiments, the smart card applications are of other suitable smart card application types or are stand-alone functions or components of data.

In one embodiment, each of the smart card applications are secure from other smart card applications stored on the smart card 404. That is, a smart card application cannot access data stored in another smart card application, unless a trust relationship exists between the smart card applications. In one embodiment, the smart card applications are isolated. That is, each smart card application is assigned a limited set of smart card resources, which the smart card application can access during its execution. In one embodiment, the smart card applications are Java Card applets and the smart card 404 includes a Java environment that assigns each applet an object space, called a context. The smart card applications (i.e., the Java Card applets) can only access data within their assigned context. Thus, access to data in a different context is prohibited. To facilitate data sharing between smart card applications, after a trust relationship is established between smart card applications, they can share data across contexts. Trust relationships can be established using public and private key cryptography, challenge-response authentication, or any other suitable technique. Other suitable security techniques are employed by alternative embodiments of the invention.

### Exemplary Implementation

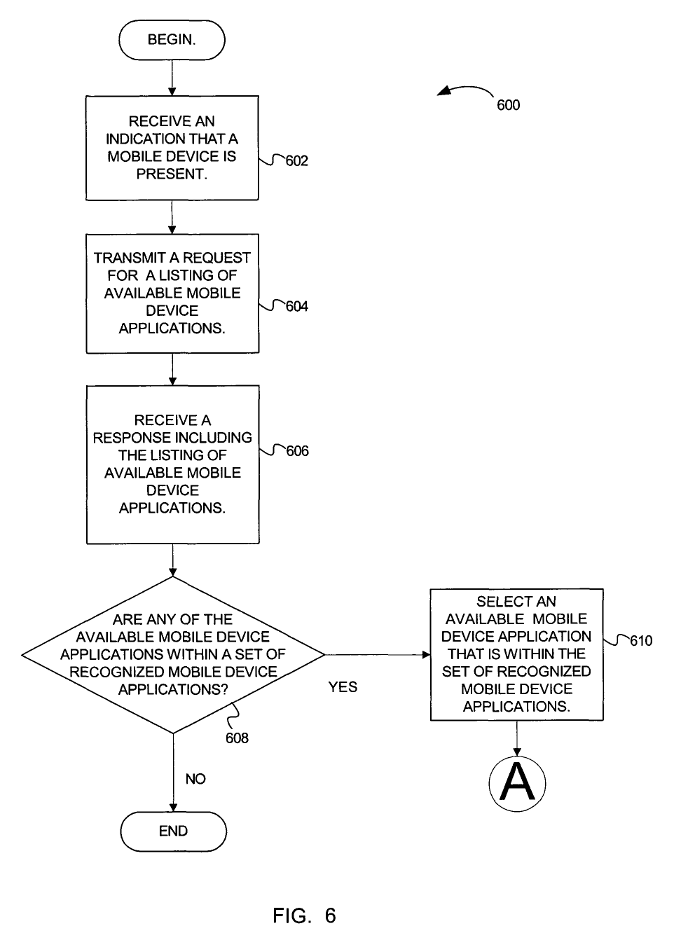

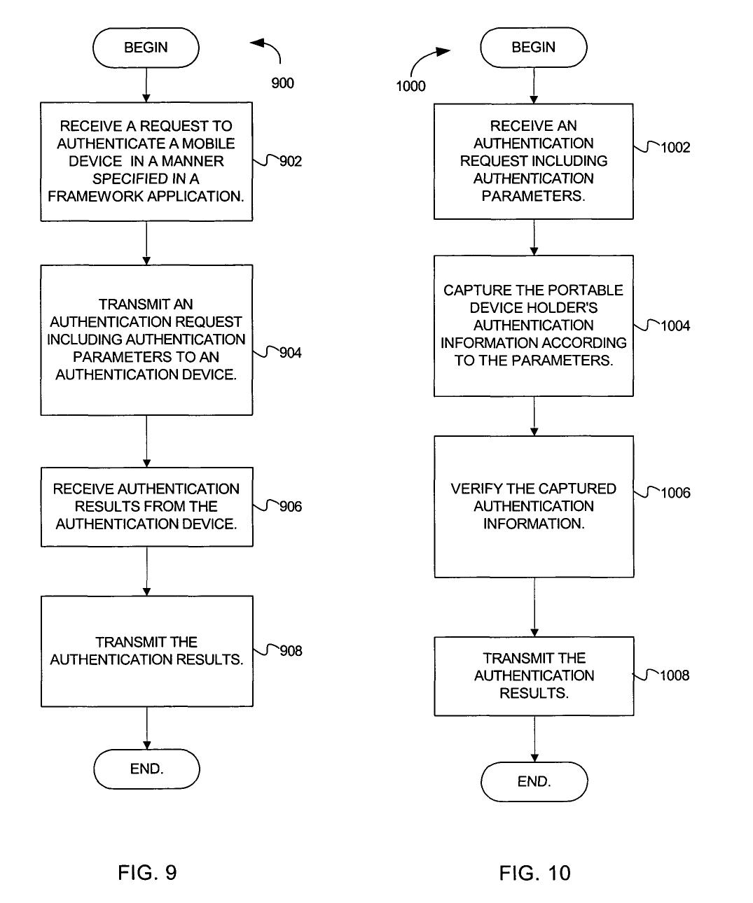

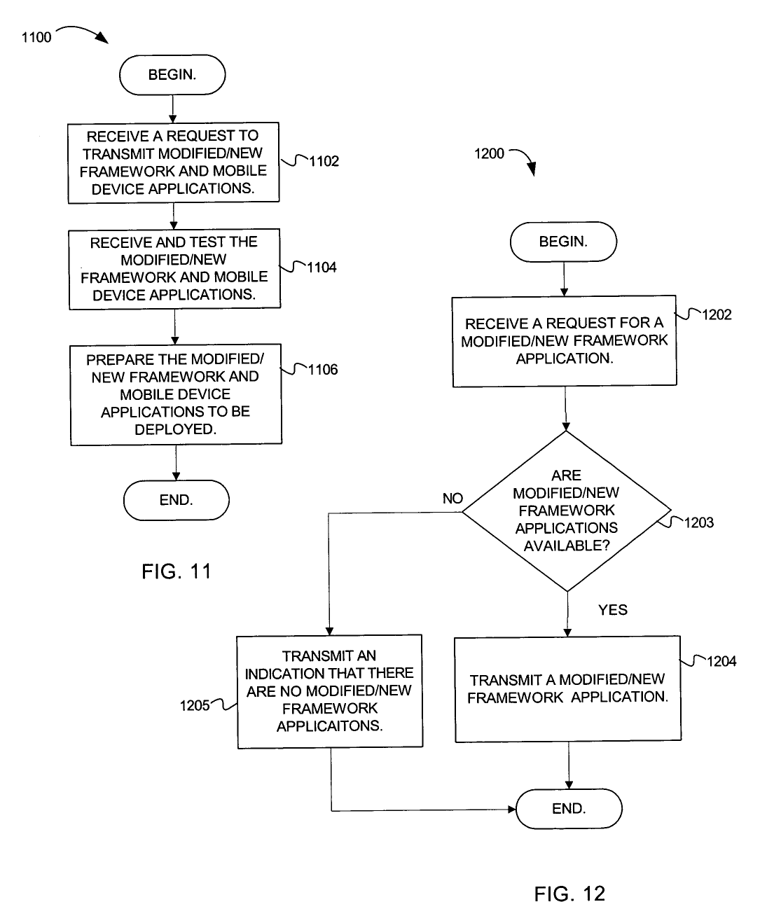

This section describes the exemplary embodiments in greater detail. In this section, FIGS. 6-13 will be presented. FIGS. 6-8 generally describe operations for receiving a mobile device, launching a framework application, and exchanging data between the mobile device and the framework application. FIGS. 9-10 describe operations for authenticating a mobile device, while FIGS. 11-13 describe operations for deploying framework applications and mobile device applications.

FIG. 6 is a flow diagram illustrating operations for exchanging data with a mobile device, according to exemplary embodiments of the invention. The flow diagram of FIG. 6 will be described with reference to the exemplary application framework of FIGS. 3 and 4. As shown in FIG. 6, the flow diagram 600 commences at block 602, where an indication that a mobile device is present is received. For example, the application framework 304 receives through the mobile device interface 334 an indication that a mobile device 336 is present. In one embodiment, the mobile device interface unit 334 forwards the indication to the mobile device access services unit 328, which delivers the indication to the framework application services unit 306. The process continues at block 604.

At block 604, a request for a listing of available mobile device applications is transmitted. For example, the framework application services unit 306 transmits a request for a listing of available mobile device applications to the mobile device 336. The process continues at block 606.

As shown block 606, a response including a listing of available mobile device applications is received. For example, the framework application services unit 306 receives a listing of available mobile device applications. In one embodiment, the listing includes a set of identification numbers corresponding to available mobile device applications. In one embodiment, the listing includes identifiers that indicate that the mobile device applications are associated with particular sponsors. The process continues at block 608.

At block 608, it is determined whether any of the available mobile device applications are within a set of recognized mobile device applications. For example, the framework application services unit 306 determines whether any of the available mobile device applications are within a set of recognized mobile device applications. In one embodiment, the framework application services unit 306 recognizes applications based on the identifiers corresponding to the mobile device applications. In one embodiment, the framework application services unit 306 recognizes applications based on whether the framework applications are associated with a certain sponsor, as indicated by the identifiers corresponding to the mobile device applications. If one or more of the available mobile device applications are within a set of recognized mobile device applications, the process continues at block 610. Otherwise, the process ends.

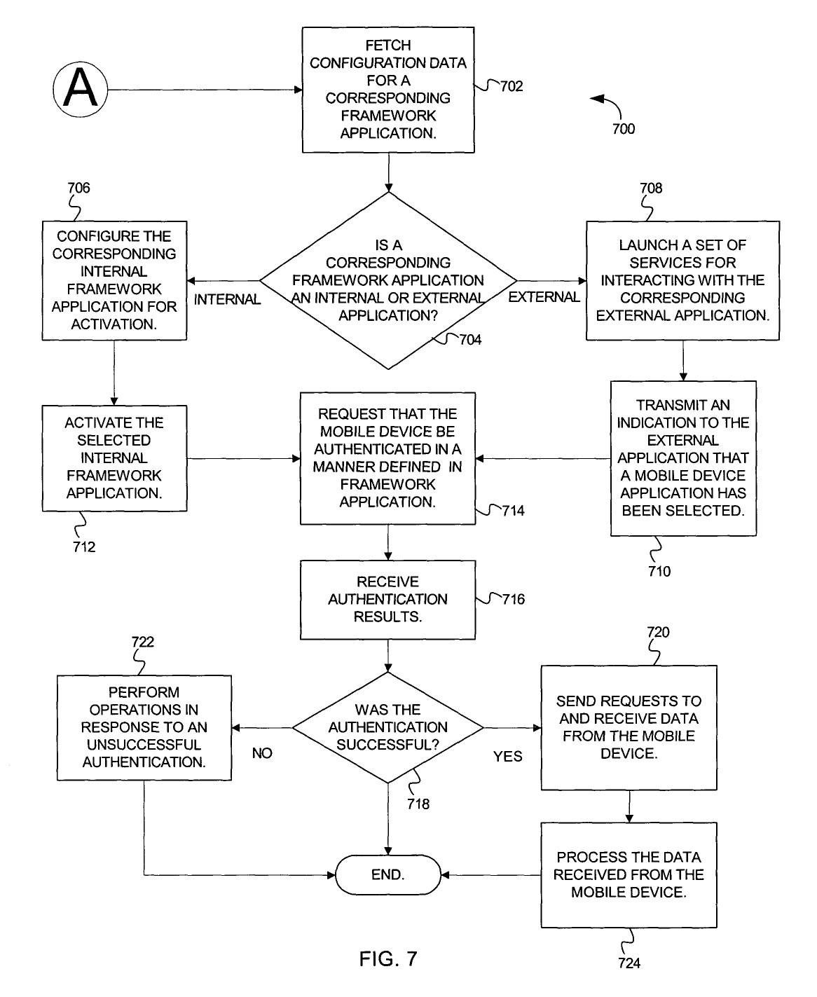

At block 610, a recognized available mobile device application is selected. For example, the framework application services unit 306 selects a recognized mobile device application. In one embodiment, the framework application services unit 306 is configured to select one particular mobile device application when only a single mobile device application is recognized. For example, the framework application services unit 306 is configured to select a certain framework application associated with a certain sponsor. In one embodiment, the framework application services unit 306 makes the selection by prompting a computing device user to select a framework application from a list of recognized mobile device applications. After receiving the computing device user selection, the framework application services unit 306 selects a framework application, which is associated with a certain sponsor, based on the computing device user selection. In one embodiment, the framework application services unit transmits a message to the mobile device 336 indicating the selected mobile device application. From block 610, the process continues at block 702 of FIG. 7. This is illustrated in FIG. 6 by the process continuing from block 610 to “A”, while in FIG. 7, the process is shown continuing from “A” to block 702.

FIG. 7 is a continuation of the flow diagram of FIG. 6, illustrating additional operations for exchanging data with a mobile device, according to exemplary embodiments of the invention. FIG. 7 will be described with reference to the exemplary embodiments described in FIGS. 3-4. The flow diagram 700 commences at block 702, where configuration data for a corresponding framework application is fetched. For example, the framework application manager unit 308 fetches configuration data, which is used for configuring a framework application corresponding with the selected mobile device application. In one embodiment, the framework application corresponds with the selected mobile device application because it is associated with the same sponsor. For example, the corresponding framework application and the selected mobile device application are both associated with a health-insurance provider (e.g., a Blue Cross and/or Blue Shield health plan). In one embodiment, the configuration data is stored in the framework application table unit 312. In one embodiment, the configuration data includes visual representation data, universal resource locators, a list of services used for communicating with the mobile device application, and/or other information used for configuring a framework application to communicate with the selected mobile device application. From block 702, the process continues at block 704.

As shown in block 704, it is determined whether a corresponding framework application is an internal framework application or an external framework application. For example, the framework application manager unit 308 determines whether a framework application corresponding to the selected mobile device application is an internal framework application or an external framework application. In one embodiment, the internal framework application unit 310 stores internal framework applications, while the external framework application unit 338 stores external framework applications. In one embodiment, the framework application unit 306 determines whether the corresponding framework application is internal or external by searching the internal framework application table unit 312. If the corresponding framework application is an internal application, the process continues at block 706. Otherwise, the process continues at block 708.

At block 708, a set of services for interacting with the corresponding external application, accessible within the same computing device (but outside the framework) or via a network, is launched. For example, the framework application services unit launches a set of services for facilitating interaction between the external application and the selected mobile device application. In one embodiment, the framework application manager unit 308 instantiates a set of Java classes to facilitate data communications between the communications services unit 334 and external servers (not shown) using serialized objects. In alternative embodiments, the framework application manager unit 308 instantiates a set of classes that facilitate data communications between the communications services unit 334 and external servers (not shown) via XML. Additionally, in one embodiment, the framework application services unit 306 also launches services for communicating with the external framework application unit 338 through the server port 322. In one embodiment, the framework application manager unit 308 launches an external framework application. For instance, an external framework application unit 338 can be activated as part of a browser-based application and launched from a specific URL. The external framework application unit 338 will subsequently subscribe to interface with the framework application services unit 306 via the server port 322. Alternatively, the external application unit may have previously subscribed to interface with the framework application services unit 306 via the server port 322. The process continues at block 710.

At block 710, an indication that a mobile device application has been selected is transmitted. For example, the framework application services unit 306 transmits to the external application unit 338 (that has previously subscribed to interact with the framework) an indication that a mobile device application has been selected. In one embodiment, the framework application services unit 306 transmits the indication through the server port 322 to an Internet browser application (not shown) running on the computing device. The Internet browser application transmits the indication on to the external framework application unit 338. From block 710, the process continues at block 714.

At block 706, the corresponding internal framework application is configured. For example, the framework application manager unit 308 configures the corresponding internal framework application, which is stored in the internal framework application unit 310, based on the configuration data (fetched at block 702). The process continues at block 712.

At block 712, the corresponding internal framework application is activated. For example, the framework application manager unit 308 activates the internal framework application that corresponds with the selected mobile device application. In one embodiment, the framework application manager unit 308 instantiates a set of Java classes, which provides the internal framework application's functionality. In alternative embodiment the framework application manager unit 308 instantiates other software for providing the internal framework application's functionality. The process continues at block 714.

At block 714, it is requested that the mobile device holder be authenticated in a manner defined by the framework application. For example, the framework application services unit 306 transmits a request to the authentication services unit 332 to authenticate the mobile device 336. In one embodiment, the authentication services unit 332 authenticates the mobile device 336 by matching information stored on the mobile device 336 with information supplied by the mobile device holder. A method for authenticating a mobile device is described in more detail below (see FIGS. 9-10). The process continues at block 716.

At block 716, the authentication results are received. For example, the framework application services unit 306 receives the authentication results from the authentication services unit 332. The process continues at block 718.

As shown at block 718, it is determined whether the authentication was successful. For example, the framework application services unit 306 determines whether the authentication was successful. If the authentication was successful, the process continues at block 720. In one embodiment, the authentication was successful if the authentication information stored in the mobile device 336 matches the authentication data provided by the mobile device holder. Otherwise, the process continues at block 722.

At block 720, requests are transmitted to and data (including transaction data) is received from the mobile device. For example, the framework application services unit 306 transmits requests to and receives data from the mobile device 336. In one embodiment, data received from the mobile device 336 includes transaction data. The process continues at block 724.

At block 724, the data received from the mobile device is processed. For example, the framework application processes the data received from the mobile device 336. In one embodiment, the framework application fetches the sponsor information from a remote storage location via the communications services unit 330, while an alternative embodiments, it fetches the sponsor information from a local data store. In one embodiment, the processing includes displaying all or part of the transaction data to a user of the computing device 302. In one embodiment, the processing includes fetching sponsor information based on the transaction data. For example, in a medical services transaction where a patient is the affiliated party and a health insurance company is the sponsor, the framework application fetches the patient's health insurance information (i.e., information describing the patient's benefits under a health insurance policy) based on the transaction data received from the mobile device 336. From block 724, the process ends.

As shown in block 722, operations in response to an unsuccessful authentication are performed. For example, in one embodiment, the framework application performs operations in response to an unsuccessful authentication. For example, the framework application requests that the authentication services unit 332 retry the authentication procedure. Alternatively, the framework application requests that the authentication services unit 332 disable the mobile device 336. Alternative embodiments perform other suitable operations for maintaining the security of the application framework 304 and mobile device 336. From block 722, the process ends.

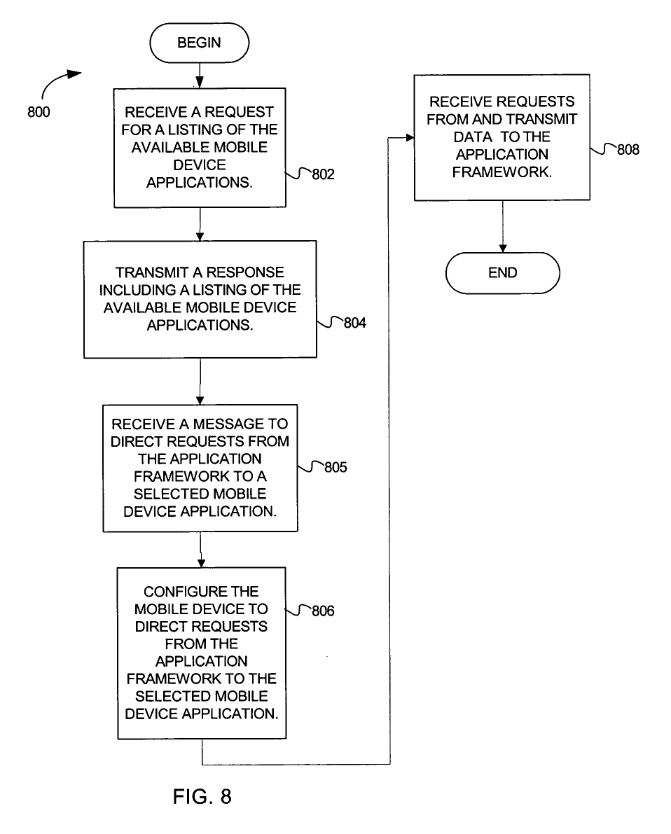

FIG. 8 is a flow diagram illustrating operations for exchanging data with an application framework, according to embodiments of the invention. The operations of FIG. 8 will be described with reference to the exemplary application framework of FIGS. 3-4. The flow diagram 800 commences at block 802.

At block 802, a request for a listing of available mobile device applications is received. For example, the mobile device 336 receives a request for a listing of the available mobile device applications from the framework application services unit 306. The process continues at block 804.

As shown at block 804, a response including a listing of the available mobile device applications is transmitted. For example, the mobile device 336 transmits a listing of available mobile device applications to the framework application services unit 306. In one embodiment, the listing includes a set of application identification numbers, as described above. The process continues at block 805.

At block 805, a message to direct request for the framework application to the selected mobile device application is received. For example, the mobile device 336 receives a message from the computing device 302 instructing it to direct messages from the framework application to the selected a mobile device application. The process continues at block 806.

At block 806, the mobile device is configured to direct requests from the application framework to the selected mobile device application. For example, the mobile device is configured to direct requests from the application framework to the selected mobile device application. In one embodiment, where the mobile device is the smart card 404, the smart card's I/O system 502 is configured to direct requests from the application framework 304 to the selected mobile device application. The process continues at block 808.

As shown at block 808, requests are received from and data (including transaction data) is transmitted to the application framework. For example, the mobile device 336 receives requests from the application framework 304 and transmits data to the application framework 304. In one embodiment, the transmitted data includes transaction data. From block 808, the process ends.

In the discussion of FIGS. 6-8 above, operations for exchanging data between a mobile device and an application framework were described. FIGS. 9-10 describe operations for authenticating a mobile device. In particular, FIG. 9 describes operations performed by a mobile device, while FIG. 10 describes operations performed by an external authentication device.

FIG. 9 is a flow diagram illustrating operations for authenticating a mobile device using an authentication device, according to exemplary embodiments of the invention. The flow diagram of FIG. 9 will be described with reference to the exemplary application framework of FIGS. 3-4. The flow diagram 900 commences at block 902, where a request to authenticate a mobile device in a manner specified in a framework application is received. For example, the authentication services unit 332 receives an authentication request from the framework application. In one embodiment, the framework application specifies a method for authenticating the mobile device 336 by passing authentication parameters. The process continues at block 904.

At block 904, the authentication request including authentication parameters is transmitted to the authentication device. For example, the authentication services unit 332 transmits the authentication request including authentication parameters to an authentication device (not shown). In one embodiment, the authentication device is a software component of the framework application. In one embodiment, the authentication device is a separate hardware device or a hardware device integrated with a mobile device reader unit. In one embodiment, the authentication parameters identify that the authentication should involve the matching of a fingerprint with a fingerprint template stored on a smart card, while in other embodiments the parameters might indicate that the authentication should involve matching of biometric information (e.g., retinal scan information, voice information, etc.) associated with a holder of the mobile device 336, or other information. In other embodiments, the authentication parameters indicate that the matching should be performed against data stored at a location indicated by the mobile device application. The process continues at block 906.

As shown at block 906, authentication results are received from the authentication device. For example, the authentication services unit 332 receives authentication results from the authentication device. The process continues at block 908.

At block 908, the authentication results are transmitted. In one embodiment, the authentication services unit 332 transmits the authentication results to the framework application services unit 306, which delivers the authentication results to a framework application. From block 908, the process ends.

FIG. 10 is a flow diagram illustrating operations performed by an authentication device for authenticating a mobile device, according to embodiments of the invention. The flow diagram of FIG. 10 will be described with reference to the exemplary application framework illustrated in FIGS. 3-4. The flow diagram 1000 commences at block 1002, where an authentication request including authentication parameters is received. For example, an authentication device receives an authentication request including authentication parameters. The process continues at block 1004.

As shown at block 1004, the portable device holder's authentication information is captured. For example, the authentication device captures the portable device holder's authentication information according to the authentication parameters. In one embodiment, the authentication device is a keypad, which prompts the mobile device holder to enter a PIN. The keypad captures the mobile device holder's PIN. In an alternative embodiment, the authentication device captures biometric authentication information. The process continues at block 1006.

At block 1006, the captured authentication information is verified with the authentication data. For example, the authentication device verifies the captured authentication information with authentication data. In one embodiment, the selected mobile device application contains authentication data. In one embodiment, the authentication data includes data associated with a party to a business transaction (e.g., an affiliated party or sponsor). In one embodiment, the authentication data is a personal identification number (PIN), while in alternative embodiments, the authentication data includes biometric information (e.g., retinal scan information, voice information, etc.) associated with a holder of the mobile device 336. In one embodiment, the selected mobile device application stores information about where the authentication data is located. In one embodiment, a pinpad smart card reader forwards the PIN entered to the mobile device 336, currently inserted in the pinpad smart card reader, to compare it with the PIN stored on the mobile device. If the PINs match, the authentication is successful. Otherwise, the authentication has failed. The process continues at block 1008.

As shown at block 1008, the authentication results are transmitted. For example, the authentication device transmits the authentication results (i.e., whether the authentication was a success or failure) to authentication services unit 332. From block 1008, the process ends.

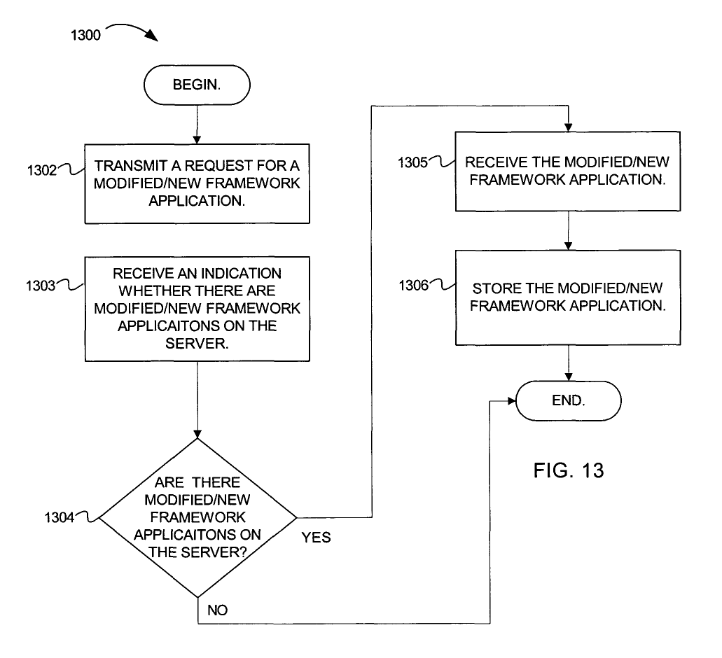

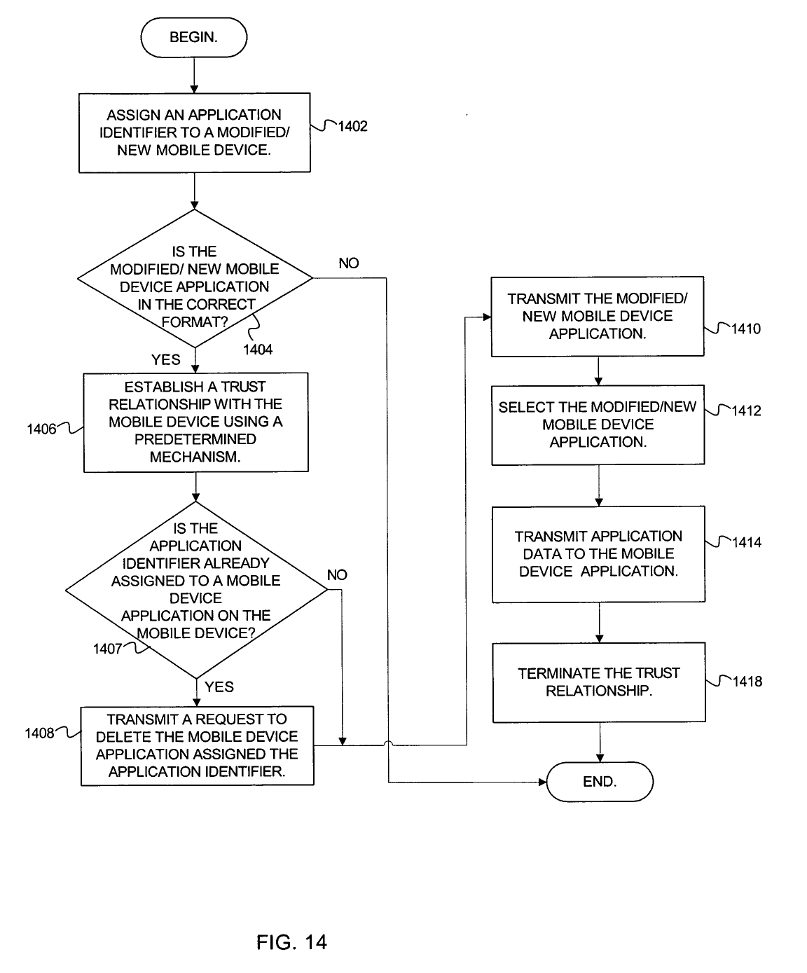

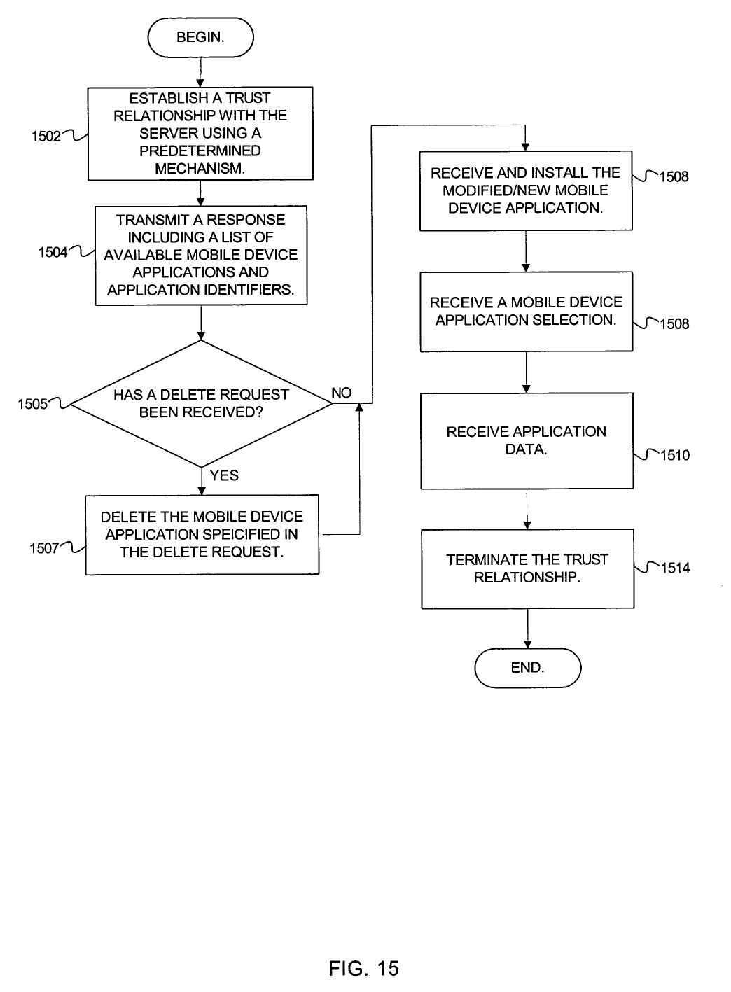

While FIGS. 6-10 describe operations for exchanging data between a mobile device and an application framework, FIGS. 11-15 describe operations for deploying the framework and mobile device applications. In particular, FIG. 11 describes receiving framework and mobile device applications in a server, which will deploy the framework and mobile device applications to computing and mobile devices. FIGS. 12-13 describe transmitting the framework applications from the server to a computing device, and FIGS. 14-15 describe transmitting the mobile device applications from the server to a mobile device.

FIG. 11 is a block diagram illustrating operations for receiving framework and mobile device applications in a server, according to embodiments of the invention. While in some embodiments the framework and mobile device applications are transmitted to a server for deployment to computing and mobile devices (as described in the following Figures), other embodiments call for deploying the framework and mobile device applications without transmitting them to a server (e.g., deploying the framework and mobile device applications directly from the application sources, such as installing/downloading the framework and/or mobile device applications from a CD or website). The operations of FIG. 11 will be described with reference to the exemplary application framework of FIGS. 3-4 and the exemplary network of FIG. 2.

The flow diagram of 1100 commences at block 1102, where a request to transmit modified/new framework and mobile device applications are to be delivered is received. For example, a server 202 receives a request to transmit modified/new framework device application from an application source device (not shown). In one embodiment, the application source device is associated with a framework application developer. In one embodiment, the server 202 is associated with an independent party acting on behalf of one or more sponsors. In one embodiment, the modified/new framework and mobile device applications include internal framework applications and/or external framework applications. Additionally, the modified/new framework and mobile device applications can include updated versions of framework and mobile device applications already deployed to a computing or mobile device. The process continues at block 1104.

At block 1104, the modified/new framework and mobile device applications are received and tested. For example, the server 202 receives and tests the modified/new framework and mobile device applications. In one embodiment, the server 202 determines whether the modified/new framework and mobile device applications are in the proper format. For example, the server 202 determines whether the modified/new framework applications are proper Java applications that can operate without impacting the existing application framework or any of the other framework applications, while it also determines whether the modified/new mobile device applications are proper Java Card applets. The process continues at block 1106.

As shown at block 1106, the modified/new framework applications are prepared for deployment. For example, the server 202 prepares the framework and mobile device applications for deployment to computing devices 302 and mobile devices 336. In one embodiment, the computing devices 302 are clients 204. In one embodiment, the preparation includes storing the modified/new framework and mobile device applications to a deployment system disposed within the server 202. From block 1106, the process ends.

FIG. 12 is a flow diagram illustrating operations for transmitting modified/new framework applications from a server to a computing device. The operations of FIG. 12 will be described with reference to the exemplary application framework shown in FIGS. 3-4. The flow diagram 1200 commences at block 1202, where a request for a modified/new framework application is received. For example, the server 202 receives a request from a computing device 302 for a modified/new framework application. The process continues at block 1203.

As shown a block 1203, it is determined whether there are any modified/new framework applications available. For example, the server 202 determines whether there are any modified/new framework applications. If there are no modified/new framework applications, the process continues at block 1205. Otherwise, the process continues at block 1204.

At block 1205, an indication that there are no modified/new framework applications is transmitted. For example, the server 202 transmits an indication that there are no modified/new framework applications. From block 1205, the process ends.

As shown a block 1204, the modified/new framework applications are transmitted. For example, the server 202 transmits the modified/new framework applications to a computing device. From block 1204, the process ends.

FIG. 13 is a flow diagram illustrating operations for receiving a framework application from a server, according to embodiments of the invention. The flow diagram of FIG. 13 will be described with reference to the exemplary application framework of FIGS. 3-4 and the exemplary network of FIG. 2.

The flow diagram 1300 commences at block 1302, where a request for a modified/new framework application is transmitted. For example, the computing device 302 transmits a request to a designated server 202 to determine whether there is a modified/new framework application. As noted above, in one embodiment, the computing device 302 is a client 204. The process continues at block 1303.

As shown in block 1303, an indication whether modified/new framework applications are available on a server is received. For example, the computing device 302 receives an indication whether modified/new framework applications are available on a server. The process continues at block 1304.

At block 1304, it is determined whether there are modified/new framework applications available on the server. If there are modified/new framework applications available on the server, the process continues at block 1305. Otherwise the process ends.

At block 1305, the modified/new framework application is received. For example, the computing device 302 receives the modified/new framework application from the server 202. The process continues at block 1306.

As shown at block 1306, the modified/new framework application is stored. For example, the computing device 302 stores the modified/new framework applications. In one embodiment, the computing device 302 stores an internal framework application in the internal framework application unit 310 and configuration data associated with the internal framework application in the framework application table unit 312, while storing configuration data associated with an external framework application in the framework application table unit 312. From block 1206, the process ends.

While FIGS. 12-13 describe deploying framework applications from a server to a computing device, FIGS. 14-15 describe deploying mobile device applications from a server to a mobile device.

FIG. 14 is a flow diagram illustrating operations for installing a modified/new mobile device application from a server to a mobile device, according to embodiments of the invention. The operations of FIG. 14 can be used before or after the mobile devices are issued to mobile device holders. The flow diagram of FIG. 14 will be described with reference to the exemplary application framework of FIGS. 3-4 and the exemplary network of FIG. 2.

The flow diagram 1400 commences at block 1402, where an application identifier is assigned to a modified/new mobile device application. For example, the server 202 assigns an application identifier to a modified/new mobile device application. In one embodiment, the application identifier is an application identification number. Alternative embodiments call for other suitable application identifiers (e.g., predetermined byte strings). The process continues at block 1404.

At block 1404, it is determined whether the modified/new mobile device application is in the correct format. For example, the server 202 determines whether the modified/new mobile device application is in the correct format. In one embodiment, the server determines whether the modified/new mobile device application is a Java Card applet in the appropriate format. If the modified/new mobile device application is in the correct format, the process continues at block 1406. Otherwise, the process ends.

At block 1406, a trust relationship is established with the mobile device using a predetermined mechanism. For example, the server 202 communicates with the application framework 304 via the server port 322 and establishes a secure channel with the mobile device 336 using a predetermined private key. In one embodiment, where the mobile device is a smart card 404, the server 202 establishes a secure channel with the smart card 404 through a smart card reader 402. The process continues at block 1407.

At block 1407, it is determined whether the application identifier is already assigned to mobile device application on the mobile device. For example, the server 202 transmits a message to the application framework 304, which communicates with the mobile device 336, to determine whether the mobile application identifier matches a mobile application identifier already assigned to a mobile device application on the mobile device 336. The message includes a request for a list of all available mobile device applications and application identifiers. If the mobile application identifier is already assigned to a mobile device application, the process continues to block 1408; otherwise the process continues to block 1410.

At block 1408, a request to delete the mobile device application that is assigned the application identifier is transmitted to the mobile device. For example, the server 202 transmits requests to the mobile device 336 to delete the mobile device application is already assigned the application identifier. The process continues at block 1410.

At block 1410, the modified/new mobile device application is transmitted. For example, the server 202 transmits the mobile device application to the application framework 304, via the server port of the 322, which in turn transmits the mobile device application to the mobile device. In one embodiment, the application framework 304 transmits the mobile device application to a smart card 404 through a smart card reader 402. The process continues at block 1412.

As shown in block 1412, server requests the application framework to select the modified/new mobile device application. For example, the server 202 transmits a request to the application framework 304, via the server port 322, to select the modified/new mobile device application. The process continues at block 1414.

At block 1414, application data is transmitted to the mobile device application. For example, the server 202 transmits application data to the application framework 304, via the server port 322, which in turn transmits the application data to the mobile device application. In one embodiment, the application data includes authentication information and/or transaction data specific to the sponsor and/or the affiliated party (mobile device holder). For example, an affiliated party's PIN, personal information and/or health plan information are transmitted to the mobile device application. From block 1414, the process continues at block 1418.

At block 1418, the trust relationship is closed. For example, application framework 304 transmits a message to close the secure channel with the mobile device 336. From block 1418, the process ends.

FIG. 15 is a flow diagram illustrating operations for receiving a modified/new mobile device application in a mobile device, according to embodiments of the invention. Flow diagram of FIG. 15 will be described with reference to the exemplary application framework of FIGS. 3-4 and the exemplary network shown in FIG. 2. The flow diagram 1500 commences at block 1502, where a trust relationship with the server is established using a predetermined mechanism. For example, the mobile device 336 and the server 202 establish secure channel using a predetermined key. In one embodiment, the predetermined key is used to authenticate the mobile device and the server, encrypt data transmitted to and from the mobile device, and ensure the integrity of the data transmitted. From block 1502, the process continues at block 1504.

As shown in block 1504, a response including a listing of the available mobile device applications and application identifiers is transmitted. For example, the mobile device 336 transmits a listing of available mobile device applications and application identifiers to the application framework 304. The process continues at block 1505.

At block 1505, it is determined whether a delete request has been received. For example, the mobile device 336 determines whether a delete request has been received. If a delete request has been received, the process continues at block 1507. Otherwise, the process continues at block 1506.

At block 1507, a mobile device application is deleted. For example, the mobile device 336 deletes the mobile device application specified in the delete request. The process continues at block 1506.

At block 1506, the mobile device application is received. For example, the mobile device 336 receives and installs the mobile device application from the application framework 304. The process continues at block 1508.

As shown at block 1508, and mobile device application selection is received. For example, the mobile device 336 receives a mobile device application selection from the server 202. In one embodiment, the server 202 transmits the mobile device application selection to the application framework 304, which transmits the mobile device application selection to the mobile device 336. The process continues at block 1510.

At block 1510, application data is received. For example, the mobile device 336 receives application data from the server 202. In one embodiment, the server 202 transmits the mobile device application selection to the application framework 304, which transmits the application data to the mobile device 336. The process continues at block 1514.

As shown at block 1514, the trust relationship is terminated. For example, the mobile device 336 receives a request from the application framework 304 and terminates the secure channel with the server 202. From block 1514, the process ends.

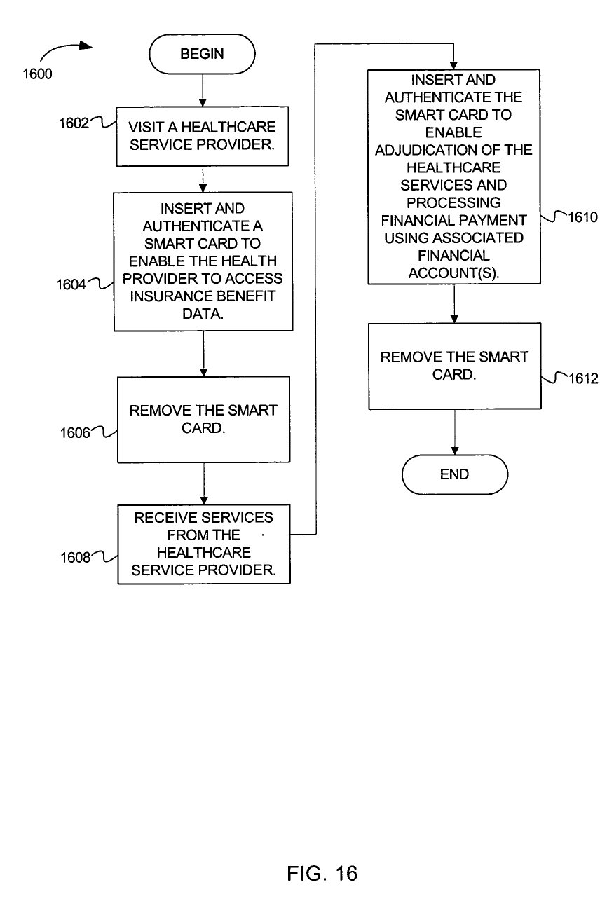

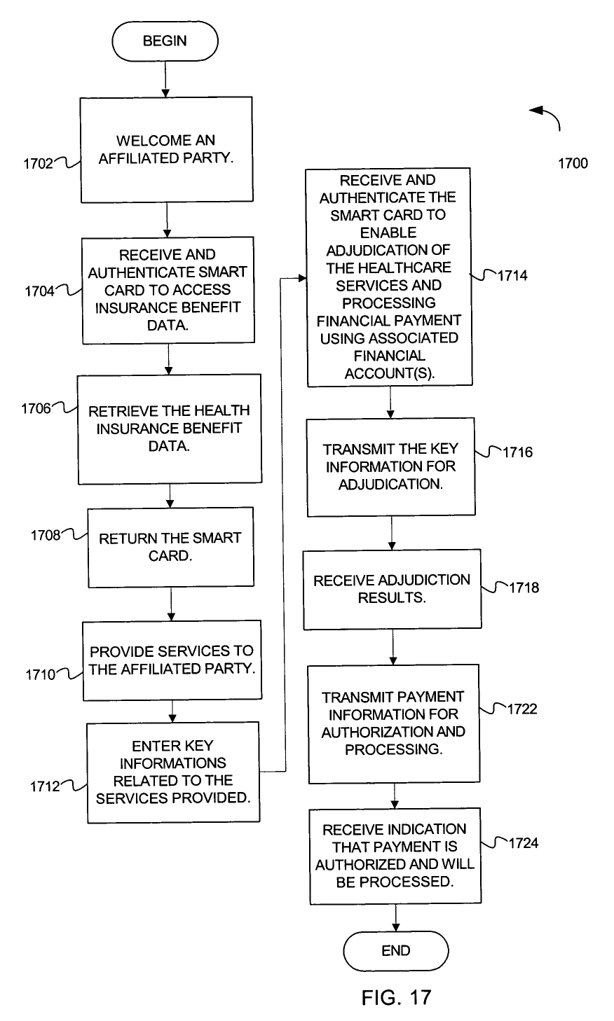

FIGS. 16 and 17 describe a method for using smart cards and the application framework for accessing health insurance and financial account information and processing payment during a transaction for health services. In particular, FIG. 16 describes actions taken by an affiliated party, while FIG. 17 describes actions taken by a health service provider.

FIG. 16 is a flow diagram illustrating actions performed by an affiliated party in the course of a medical services transaction, according to embodiments of the invention. The flow diagram 1600 will be described with reference to the exemplary embodiments shown in FIGS. 3-4. The flow diagram 1600 commences at block 1602, where a health provider is visited. For example, an affiliated party visits a health provider. Flow continues at block 1604.

At block 1604, a smart card is inserted and authenticated to enable the health provider to access insurance benefit data. For example, the affiliated party inserts a smart card 402 into a card reader 404 and authenticates the smart card to enable the health provider to access the affiliated party's health insurance benefit data. In one embodiment, the insurance benefit data is transaction data including financial account data. In one embodiment the smart card contains insurance benefit data. In one embodiment, the health insurance benefit data is stored in a remote computer maintained by a health insurance company that provides health insurance to the affiliated party. In this transaction, the health insurance company is a sponsor. The process continues at block 1606.

As shown block 1606, the smart card is removed. For example, the affiliated party removes the smart card 402 from the card reader 404. The process continues at block 1608.

As shown block 1608, health care services are received from the health provider. For example, affiliated party receives services (e.g., treatment for illnesses etc.) from the health provider. The process continues at block 1610.

At block 1610, the smart card is inserted and authenticated to enable adjudication of health care services and processing of financial payment using associated financial account(s). For example, the affiliated party inserts and authenticates the smart card 402 to enable adjudication of the health care services and processing of financial payment using the financial account data. In one embodiment the financial account data is used to access an associated financial account(s). In one embodiment, a remotely located independent party performs the adjudication. In one embodiment, adjudication includes evaluating information about the procedures performed and diagnoses received. In one embodiment the information about the procedures performed and diagnoses received is used to determine whether the procedures performed and diagnoses received can be paid for from one or more specific financial accounts. The process continues at block 1612.

As shown block 1612, the smart card is removed. For example, the affiliated party removes a smart card 402 from the card reader 404. From block 1612, the process ends.

FIG. 17 is a flow diagram illustrating actions performed by a health provider in the course of a medical services transaction, according to embodiments of the invention. The flow diagram 1700 will be described with reference to the exemplary embodiments shown in FIGS. 3-4. The flow diagram 1700 commences at block 1702, where an affiliated party is visited. For example, the health provider welcomes an affiliated party that visits the health provider's office. The process continues at block 1704.

At block 1704, a smart card is received and authenticated to enable access to insurance benefit data. For example, the health provider receives the affiliated party's smart card 402 in a card reader 404, which is authenticated by the affiliated party, to access the affiliated party's insurance benefit data. In one embodiment, the insurance benefit data includes financial account data (e.g., financial account data can include account numbers, routing numbers, etc.). In one embodiment the smart card 402 contains insurance benefit data. The process continues at block 1706.

At block 1706, the insurance benefit data is retrieved. For example, the health provider retrieves the affiliated party's health benefit data using a framework application instantiated in response to receiving the smart card 402. In one embodiment, the framework application uses information and functionality provided by the smart card 402 to retrieve insurance benefit data from a remote computer maintained by a health insurance company that provides health insurance to the affiliated party. In one embodiment the framework application retrieves insurance benefit data from the smart card. The process continues at block 1708.

As shown in block 1708, the smart card is returned. For example, the health provider allows the affiliated party to remove the smart card 402 from the smart card reader 404. The process continues at block 1710.

As shown in block 1710, health care services are provided to the affiliated party. For example, the health provider provides health care services to the affiliated party. The process continues at block 1712.

At block 1712, key information related to the health care services provided are entered. For example, a health provider administrator enters procedure and diagnostic codes based on the health care services that were provided to the affiliated party. In one embodiment, the procedure and diagnostic codes are entered into the framework application. In one embodiment, the procedure and diagnostic codes are transmitted from another system into the framework application. The process continues at block 1714.

As shown in block 1714, the smart card is received and authenticated. For example, the affiliated party inserts the smart card 402 into the smart card reader 404 and authenticates the smart card to enable adjudication of health care services and processing of financial payment using associated financial account(s). The process continues at block 1716.

At block 1716, the key information related to the health care services provided is transmitted for adjudication. For example, the health provider transmits the procedure and diagnostic codes to a remotely located independent party for adjudication. In one embodiment, a framework application transmits the procedure and diagnostic codes to a remote computer. In one embodiment, the information about the procedures performed and diagnoses received is used to qualify the services to be paid for from one or more specific financial accounts. The process continues at block 1718.

As shown block 1718, an adjudication result is received. For example, the health provider receives approval from the party that performed the adjudication. In one embodiment, the approval is received by a framework application. The process continues at block 1722.

At block 1722, payment information is transmitted to a payment processor for authorization and processing. For example, the health provider submits payment information to a payment processor. In one embodiment, the payment information is automatically transmitted by a framework application. In one embodiment, the financial account(s) that are to be used to process payment were pre-adjudicated for payment of the services and diagnoses received, as described under block 1716. The process continues at block 1724.

At block 1724, a payment indication is authorized and will be processed. For example, the health provider receives an indication that payment has been authorized and will be processed. In one embodiment, the framework application receives an indication that payment is authorized and will be processed. From block 1724, the process ends.

Thus, a method and system for integrating and instantiating custom applications in a multi-application smart card system have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

We claim:

1. A method comprising:
receiving an indication that a mobile device is operative for data transmission, the mobile device including a first set of one or more mobile device applications, wherein each mobile device application is associated with one or more of a second set of framework applications;
selecting a mobile device application from the first set;
selecting a framework application from the second set, wherein the mobile device application is associated with the framework application;
activating the framework application, wherein activating includes successfully authenticating the mobile device; and
after activating the framework application, receiving transaction data from the mobile device application.

2. The method of claim 1, wherein the mobile device is a smart card.

3. The method of claim 1, wherein the computing device located at a service provider location.

4. The method of claim 3, where the service provider location is a physician's office, clinic, hospital or location where healthcare services are performed.

5. The method of claim 1, wherein the mobile device applications of the first set are each provided by a sponsor.

6. The method of claim 5, wherein the sponsors include a health insurance company.

7. The method of claim 5 wherein the sponsors include a financial services company.

8. The method of claim 5, wherein the sponsor includes a healthcare provider.

9. The method of claim 5 wherein the sponsor includes a healthcare services administrator.

10. A method comprising:
receiving an indication that a smart card is operative for data transmission, wherein the smart card includes a smart card application, wherein the smart card application includes transaction data, and wherein the transaction data is inaccessible until the smart card is authenticated;
selecting the smart card application, wherein the smart card application is configured to communicate with a framework application;
instantiating the framework application, wherein instantiating includes successfully authenticating the smart card, wherein the smart card is authenticated according to an authentication method designated by the framework application; and
receiving the transaction data from the smart card application.

11. The method of claim 10, wherein the framework application is instantiated through an Internet browser.

12. The method of claim 10, where the smart card application is a Java Card applet.

13. The method of claim 10, wherein the smart card application and the framework application are associated with one or more sponsors.

14. The method of claim 13, wherein the sponsors include a health insurance company.

15. The method of claim 13, wherein the sponsors include a financial services company.

16. The method of claim 13, wherein the sponsor includes a healthcare provider.

17. The method of claim 13, wherein the sponsor includes a healthcare services administrator.

18. A method comprising:
transmitting to an application framework a first indication that a smart card is available, wherein the smart card includes a first set of one or more smart card applications, wherein each smart card application of the first set includes transaction data, wherein each smart card application of the first set is associated with one or more of a plurality of framework applications;
receiving a second indication from the application framework that a smart card application from the first set is selected;
authenticating the smart card according to an authentication method designated by one of the plurality of framework applications; and
after authenticating the smart card, transmitting transaction data to the application framework.

19. The method of claim 18, wherein, the smart card applications are Java Card applets.

20. The method of claim 18, wherein the transaction data includes a patient's name and health plan information.

21. The method of claim 18, wherein smart card applications of the first set and the plurality of framework applications are associated with one or more sponsors.

22. The method of claim 21, wherein the sponsors include a health insurance company.

23. The method of claim 21, wherein the sponsors include a financial services company.

24. A method comprising:
transmitting an first indication that a mobile device is operative for data transmission, wherein the mobile device includes a set of one or more mobile device applications, wherein each of the mobile device applications includes transaction data, and wherein the transaction data is inaccessible until the mobile device is authenticated;
receiving a second indication that a mobile device application of the set of mobile device applications is selected;
authenticating the mobile device;
receiving a request for the mobile device application's transaction data from a framework application of a plurality of framework applications;
transmitting the transaction data to the framework application.

25. The method of claim 24, where the mobile device applications are Java Card applets.

26. The method of claim 24, wherein the authentication data includes a personal identification number (PIN).

27. The method of claim 24, wherein smart card applications of the first set and the plurality of framework applications are associated with one or more sponsors.

28. The method of claim 27, wherein the sponsors include a health insurance company.

29. The method of claim 27, wherein the sponsors include a financial services company.

30. An apparatus comprising:
an application framework, the application framework including,
a mobile device interface unit to receive an indication that a mobile device is operative for data transmission, the mobile device including a set of one or more mobile device applications, wherein each of the mobile device applications includes transaction data, and wherein the transaction data is inaccessible until the mobile device is authenticated;
a framework application manager coupled with the mobile device interface, the framework application manager to activate an internal framework application or an external framework application after the indication is received;
an authentication services unit to perform operations for authenticating the mobile device; and
a mobile device interface unit to receive the transaction data from the mobile device and to transmit the transaction data to the internal framework application or the external framework application.

31. The apparatus of claim 28, wherein the mobile device is a smart card.

32. The apparatus of claim 28, wherein the transaction data includes health insurance information of a patient.

33. The apparatus of claim 28, wherein the mobile device applications are Java Card applets.

34. An apparatus comprising:
a smart card, the smart card including,
a memory unit to store a set of one or more smart card applications, wherein each of the smart card applications includes transaction data that is inaccessible until the smart card is authenticated, and wherein each of the smart card applications is associated with one or more of a plurality of framework applications; and
a central processing unit to transmit to an application framework an indication that the smart card is available, to process a smart card application selection received from a framework application of the plurality of framework applications, and to transmit the smart card application's transaction data to the framework application.

35. The apparatus of claim 34, wherein the transaction data of each of the smart card applications is not accessible until the framework application authenticates the smart card.

36. The apparatus of claim 36, wherein the smart card applications are Java Card applets and the framework application is a Java application.

37. The apparatus of claim 36, wherein ones of the set of smart card applications and ones of the plurality of framework applications are associated with one or more sponsors.

38. A machine-readable medium that provides instructions, which when executed by a machine, cause said machine to perform operations comprising:
receiving an indication that a mobile device is operative for data transmission, the mobile device including a first set of one or more mobile device applications, wherein each mobile device application is associated with one or more of a second set of framework applications;
selecting a mobile device application from the first set;
selecting a framework application from the second set, wherein the mobile device application is associated with the framework application;
activating the framework application, wherein activating includes successfully authenticating the mobile device; and
after activating the framework application, receiving transaction data from the mobile device application.

39. The machine-readable medium of claim 38, wherein the mobile device is a smart card.

40. The machine-readable medium of claim 38, wherein the computing device located at a service provider location.

41. The machine-readable medium of claim 40, where the service provider location is a physician's office, clinic, hospital or location where healthcare services are performed.

42. The machine-readable medium of claim 38, wherein the mobile device applications of the first set are each provided by a sponsor.

43. The machine-readable medium of claim 42, wherein the sponsors include a health insurance company.

44. The machine-readable medium of claim 42, wherein the sponsors include a financial services company.

45. The machine-readable medium of claim 42, wherein the sponsor includes a healthcare provider.

46. The machine-readable medium of claim 42, wherein the sponsor includes a healthcare services administrator.

47. A machine-readable medium that provides instructions, which when executed by a machine, cause said machine to perform operations comprising:
receiving an indication that a smart card is operative for data transmission, wherein the smart card includes a smart card application, wherein the smart card application include transaction data, and wherein the transaction data is inaccessible until the smart card is authenticated;
selecting the smart card application, wherein the smart card application is configured to communicate with a framework application;
instantiating the framework application, wherein instantiating includes successfully authenticating the smart card, wherein the smart card is authenticated according to an authentication method designated by the framework application; and
receiving the transaction data from the smart card application.

48. The machine-readable medium of claim 47, wherein the framework application is instantiated through an Internet browser.

49. The machine-readable medium of claim 47, where the smart card application is a Java Card applet.

50. The machine-readable medium of claim 47, wherein the smart card application and the framework application are associated with one or more sponsors.

51. The machine-readable medium of claim 50, wherein the sponsors include a health insurance company.

52. The machine-readable medium of claim 50, wherein the sponsors include a financial services company.

53. The machine-readable medium of 50, wherein the sponsor includes a healthcare provider.

54. The machine-readable medium of 50, wherein the sponsor includes a healthcare services administrator.

55. A machine-readable medium that provides instructions, which when executed by a machine, cause said machine to perform operations comprising:
transmitting to an application framework a first indication that a smart card is operative for data transmission, wherein the smart card includes a first set of one or more smart card applications, wherein each smart card application of the first set includes transaction data, wherein each smart card application of the first set is associated with one or more of a plurality of framework applications;
receiving a second indication from the application framework that a smart card application from the first set is selected;
authenticating the smart card according to an authentication method designated by one of the plurality of framework applications; and
after authenticating the smart card, transmitting transaction data to the application framework.

56. The machine-readable medium of claim 55, wherein, the smart card applications are Java Card applets.

57. The machine-readable medium of claim 55, wherein the transaction data includes a patient's name and health plan information.

58. The machine-readable medium of claim 55, wherein smart card applications of the first set and the plurality of framework applications are associated with one or more sponsors.

59. The machine-readable medium of claim 58, wherein the sponsors include a health insurance company.

60. The machine-readable medium of claim 58, wherein the sponsors include a financial services company.

61. A machine-readable medium that provides instructions, which when executed by a machine, cause said machine to perform operations comprising:
transmitting an first indication that a mobile device is available, wherein the mobile device includes a set of one or more mobile device applications, wherein each of the mobile device applications includes transaction data, and wherein the transaction data is inaccessible until the mobile device is authenticated;
receiving a second indication that a mobile device application of the set of mobile device applications is selected;
authenticating the mobile device;
receiving a request for the mobile device application's transaction data from a framework application of a plurality of framework applications;
transmitting the transaction data to the framework application.

62. The machine-readable medium of claim 61, where the mobile device applications are Java Card applets.

63. The machine-readable medium of claim 61, wherein the authentication data includes a personal identification number (PIN).

64. The machine-readable medium of claim 61, wherein smart card applications of the first set and the plurality of framework applications are associated with one or more sponsors.

65. The machine-readable medium of claim 64, wherein the sponsors include a health insurance company.

66. The machine-readable medium of claim 64, wherein the sponsors include a financial services company.
